(19) United States
(12) Patent Application Publication
(10) Pub. No.: US 2005/0282293 A1
(43) Pub. Date: Dec. 22, 2005

(54) System for delivering a diluted solution

(76) Inventors: Maury D. Cosman, Medfield, MA (US); Ravi Kapur, Boston, MA (US); Bruce L. Carvalho, Watertown, MA (US); Tom Barber, Cambridge, MA (US); Ulysses J. Balis, Peabody, MA (US); Mehmet Toner, Wellesley, MA (US); Lotien R. Huang, Brookline, MA (US); Darren S. Gray, Brookline, MA (US)

Correspondence Address: CLARK & ELBING LLP, 101 FEDERAL STREET, BOSTON, MA, 02110, US

(21) Appl. No.: 11/071,270

(22) Filed: Mar. 3, 2005

Related U.S. Application Data
(60) Provisional application No. 60/549,680, filed on Mar. 3, 2004.

(51) Int. Cl. G01N 1/10

(52) U.S. Cl. 436/180

(57) ABSTRACT

The invention features methods and devices for the delivery of a fluid medium containing analytes, e.g., particles, solutes, or solvents, to an analytical device. The systems are designed to minimize contact with potentially hazardous, fragile, or valuable samples. The systems allow for the dilution, mixing, and introduction of the fluid medium to an analytical device, followed by possible further analysis or sample manipulation.

### CROSS-REFERENCE TO RELATED APPLICATIONS

This application claims benefit of U.S. Provisional Application No. 60/549,680, filed Mar. 3, 2004, which is hereby incorporated by reference.

### BACKGROUND OF THE INVENTION

The invention relates to the field of sample delivery and microfluidics.

Blood samples are routinely drawn for diagnostic purposes in standardized glass collection tubes containing anticoagulants such as EDTA, citrate, or heparin. The Vacutainer brand (e.g., from Becton Dickinson) of tubes facilitates drawing of patient blood samples by virtue of a partial vacuum in the tube, which is retained during storage of the tubes by a silicone rubber stopper/septum. It is however difficult to transfer cells from such containers to analytical devices in an automated way. For example, blood cells may sediment potentially leading to inaccurate blood counts. In addition, the transfer of blood and subsequent mixing with reagents or diluents may lead to cell loss, sample contamination from the environment, or risk of infection to personnel.

Thus, there is a need for improved methods of transfer of blood from storage containers to analytical devices.

### SUMMARY OF THE INVENTION

The invention features methods and devices for the delivery of a fluid medium containing analytes, e.g., particles, solutes, or solvents, to an analytical device. The systems are designed to minimize contact with potentially hazardous, fragile, or valuable samples. The systems allow for the dilution, mixing, and introduction of the fluid medium to an analytical device, followed by possible further analysis or sample manipulation.

In one aspect, the invention features a method for delivering analytes to an analytical device including the steps of providing a sample container having an outlet and containing a fluid medium including the analyte; the analytical device; and a transfer line fluidically connecting the outlet and the analytical device; and pumping at least a portion of the fluid medium through the outlet and the transfer line into the analytical device, during which the fluid medium in the sample container is agitated to substantially maintain homogeneity. The transfer line may include a diluent inlet through which diluent can be introduced in order to dilute the sample prior to introduction into the analytical device. The transfer line or the analytical device may further include a mixer capable of mixing the fluid medium and the diluent.

The invention also features an alternative method for delivering analytes to an analytical device including providing a sample container having an outlet and containing a fluid medium including the analytes; the analytical device; a fluidic switch; and a diluent reservoir containing diluent, wherein the outlet is fluidically connected to the analytical device, and the fluidic switch is fluidically connected to the analytical device and the diluent reservoir; pumping the diluent through the fluidic switch and the analytical device into the sample container to dilute the sample, wherein the fluidic switch directs the diluent into the analytical device; and pumping at least a portion of the diluted sample through the outlet and into the analytical device, during which the diluted sample in the sample container is agitated to substantially maintain homogeneity. In this method, the diluted sample may be pumped through the analytical device, e.g., in its entirety. The fluidic switch may prevent the diluted sample from entering the diluent reservoir, e.g., by directing the sample that has passed through the analytical device to a waster container.

Another method of the invention for delivering analytes to an analytical device includes providing a sample container having an outlet and containing a fluid medium including the analytes; the analytical device; and a diluent reservoir containing diluent, wherein the outlet is fluidically connected to the analytical device, and the analytical device is fluidically connected to the diluent reservoir; pumping diluent from the diluent reservoir through the analytical device and the outlet into the sample container to dilute the sample; and pumping at least a portion of the diluted sample from the sample container through the outlet into the analytical device, during which the diluted sample in the sample container is agitated to substantially maintain homogeneity.

An additional method of the invention for delivering analytes to an analytical device includes providing a sample container having an outlet and containing a fluid medium comprising the analytes; a diluent reservoir containing diluent; and the analytical device, wherein the outlet is fluidically connected to the diluent reservoir, and the diluent reservoir is fluidically connected to the analytical device; pumping at least a portion of the fluid medium from the sample container through the outlet into the diluent reservoir to dilute the sample, during which the fluid medium in the sample container is agitated to substantially maintain homogeneity; and pumping at least a portion of the diluted sample from the diluent reservoir into the analytical device, during which the diluent reservoir is agitated to substantially maintain homogeneity in the diluted sample.

In various embodiments, the agitation, e.g., used to reduce sedimentation of particles in the medium, occurs by applying mechanical or acoustical force or by circulating the medium. The sample container may also have an inlet, which may or may not be in fluid contact with the fluid medium. Such an inlet may be coaxial with the outlet. Any container, e.g., for sample or diluent, that is pressurized in the methods of the invention may contain a pressure release valve. Pumping may occur, for example, by introducing a pressurizing fluid into a container to force at least a portion of the fluid out of the container. The fluid medium may be, for example, a biological fluid including blood, lymph, semen, urine, cerebrospinal fluid, saliva, or a cell suspension, and the analytes may include particles, such as cells. When the analytes are delivered to the analytical device, they may be analyzed, e.g., by contacting the analytes with a labeling moiety (for example, for in situ hybridization analysis of cells). A portion of the analytes may also be selectively retained in the analytical device, e.g., through binding to capture moieties or size, shape, or deformability based retention. The analytical device may also be rinsed after analytes are introduced therein. In addition, additional diluents, e.g., containing reagents or rinses, may be introduced into the analytical device. The introduction of such additional diluents may be controlled by a fluidic switch.

In another aspect, the invention features a delivery system including an analytical device; a transfer line fluidically connected to the analytical device, wherein a sample container is capable of being fluidically connected to the transfer line; and an agitator capable of substantially maintaining homogeneity in a fluid medium. As above, the transfer line comprises a diluent inlet through which diluent can be introduced. The transfer line may also include a mixer capable of mixing diluent and a fluid medium.

Another delivery system of the invention includes an analytical device capable of being fluidically connected to a sample container; a fluidic switch; a diluent reservoir; and an agitator capable of substantially maintaining homogeneity in a fluid medium, wherein the fluidic switch is fluidically connected to the analytical device and the diluent reservoir, and wherein the fluidic switch is capable of preventing the flow of fluid between the analytical device and the diluent reservoir.

The invention also features a delivery system including an analytical device capable of being fluidically connected to a sample container; a diluent reservoir, wherein the analytical device is fluidically connected to the diluent reservoir; and an agitator capable of substantially maintaining homogeneity in a fluid medium.

An additional delivery system of the invention includes a diluent reservoir capable of being fluidically connected to a sample container; an analytical device fluidically connected to the diluent reservoir; and an agitator capable of substantially maintaining homogeneity in a fluid medium.

In another aspect, the invention features a plug for a sample container. The plug has a top having a depression and a bottom, and, when inserted into a sample container, the top is in contact with the sample. A first port traverse the plug from the top to the bottom and is in fluidic connection with the depression, and a second port traverses the plug from the top to the bottom and is not in fluidic contact with the depression. The second port may be connected to a pressure source, and the first port may be connected to a transfer line capable of being connected to an analytical device.

The systems and plugs of the invention may be employed in the methods described herein. In addition, the wetting methods described herein may be used to enhance the introduction of fluid media in the methods and systems of the invention.

By “analyte” is meant a molecule, other chemical species, e.g., an ion, or particle. Exemplary analytes include cells, viruses, nucleic acids, proteins, carbohydrates, and small organic molecules.

By “analytical device” is meant any device suitable for preparation, separation, modification, analysis, storage, or performing any other desirable activity on a sample.

By “capture moiety” is meant a chemical species to which an analyte binds. A capture moiety may be a compound coupled to a surface or the material making up the surface. Exemplary capture moieties include antibodies, oligo- or polypeptides, nucleic acids, other proteins, synthetic polymers, and carbohydrates.

By “diluent” is meant any fluid that is miscible with the fluid medium of a sample. Typically diluents are liquids. A diluent, for example, contains agents to alter pH (e.g., acids, bases, or buffering agents) or reagents to chemically modify analytes in a sample (e.g., to label an analyte, conjugate a chemical species to an analyte, or cleave a portion of an analyte) or to effect a biological result (e.g., growth media or chemicals that elicit a cellular response or agents that cause cell lysis). A diluent may also contain agents for use in fixing or stabilizing cells, viruses, or molecules. A diluent may also be chemically or biologically inert.

By “microfluidic” is meant having one or more dimensions of less than 1 mm. For example, a microfluidic device includes a microfluidic channel having a height, width, or length of less than 1 mm.

By “particle” is meant an object that does not dissolve in a solution on the time scale of an analysis.

By “specifically binding” a type of analyte is meant binding analytes of that type by a specified mechanism, e.g., antibody-antigen interaction, ligand-receptor interaction, nucleic acid complementarity, protein-protein interaction, charge-charge interaction, and hydrophobic-hydrophobic or hydrophilic-hydrophilic interactions. The strength of the bond is generally enough to prevent detachment by the flow of fluid present when analytes are bound, although individual analytes may occasionally detach under normal operating conditions.

By “specifically retained” is meant retained based on a specific characteristic, e.g., size, shape, deformability, or chemical identity.

Other features and advantages will be apparent from the following description and the claims.

### BRIEF DESCRIPTION OF THE DRAWINGS

FIG. 1a is a schematic diagram of a delivery system including inline dilution.

FIG. 1b is a schematic diagram of a delivery system including an online mixer and online dilution.

FIG. 1c is a schematic diagram of a delivery system including on-chip mixing in a microfluidic device (i.e., chip) and online dilution.

FIG. 2a is a schematic diagram of a delivery system as described in Example 2.

FIG. 2b is a schematic diagram of a delivery system as described in Example 2.

FIG. 2c is a schematic diagram of a sample container having a cone-shaped bottom in order to maximize sample removal.

FIG. 3 is a schematic diagram of a delivery system as described in Example 3.

FIG. 4 is a schematic diagram of a plug for a sample container that provides an inlet and an outlet.

The drawings are not necessarily to scale.

### DETAILED DESCRIPTION OF THE INVENTION

It is often desirable to automate the transfer of a fluid medium containing analytes, e.g., blood cells, from a sample container to an analytical device. Automated transfer is also beneficial in situations where the analysis requires a relatively constant flow of fluid medium at relatively low flow rates, and avoiding sedimentation of any particles or separation of immiscible fluids is desirable. It may also be desirable to mix a sample with appropriate diluents, e.g., those containing anticoagulants or other reagents, to facilitate subsequent processing and analysis. Automated sample processing is also important for samples that may create hazardous aerosols or be biohazards or susceptible to contamination or degradation. With such samples, processing without a technician needing to open the container is preferable. Furthermore, when a sample is being delivered to an analytical device, especially a microfluidic device, for analysis, methods that enhance wetting of the device in order to avoid entrapping bubbles, which could interfere with the analysis, are desirable.

Several embodiments of a system that delivers a fluid medium, e.g., a homogeneous mixture of particles, such as blood, to an analytical device, while also providing the ability to mix diluents with the sample, are described below. Each of these embodiments will be described specifically with respect to a blood sample, but the methods and devices are broadly applicable to other fluid media, e.g., solutions, suspensions, or mixtures of particles in a fluid medium.

### EXAMPLE 1

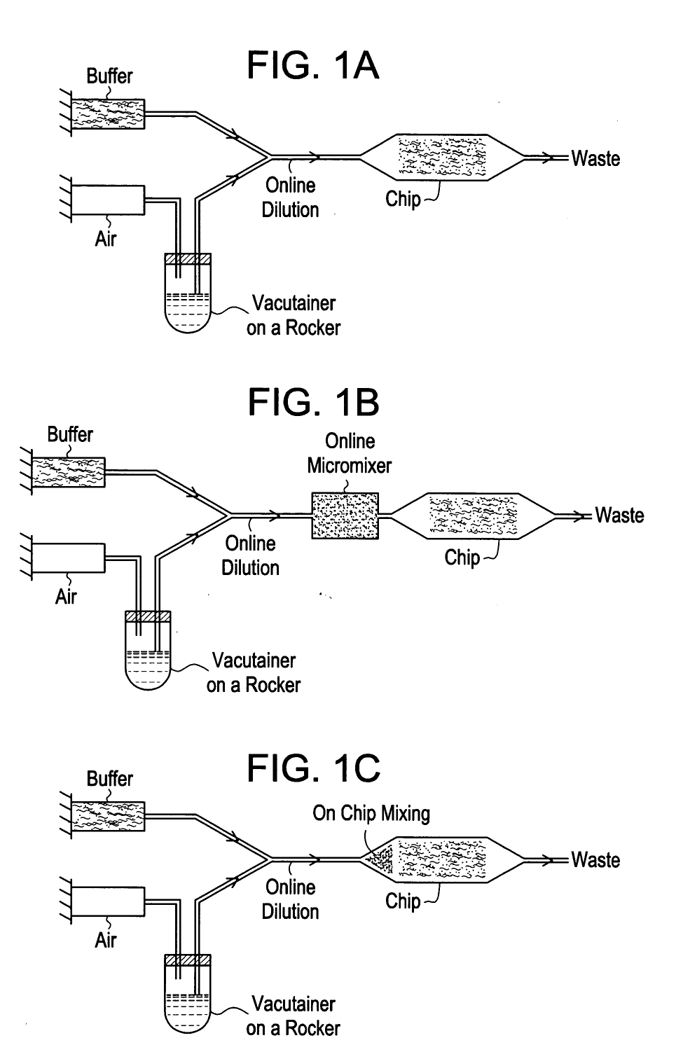

This system is described with reference to FIGS. 1a-1c. The system is based on positive displacement of blood from a sample container with inline dilution, control of sedimentation, and optional enhancement of mixing. A positive displacement pump, e.g., a syringe pump, drives a pressurizing fluid, such as air or immiscible oil, into the sample container through an inlet, e.g., a needle penetrating a septum. This influx of fluid displaces blood through an outlet, e.g., a second needle penetrating the septum (FIG. 1a). In order to enable extraction of the majority of the blood sample from the sample container, the outlet is preferably long enough to reach the bottom of the tube. Sedimentation is prevented by mechanically rocking the container through an angle of slightly less than 180°, such that the tip of the inlet does not contact the blood. This arrangement avoids entrainment of pressurizing fluid in the blood to be delivered to an analytical device. Diluent may be supplied from a reservoir by a second positive displacement pump to provide any desired level of dilution of the blood sample. Because of the low Reynolds-number laminar-flow regime of the sample and diluent, a means to enhance mixing of the streams, by putting energy into the system, may be employed. One method for accomplishing this is through the use of an acoustic transducer or mechanical fluid mixer (FIG. 1b). An alternate approach is to create a zone of higher Reynolds-number flow, in the turbulent regime, e.g., through the use of a microfabricated channel on the front end of a microfluidic device (FIG. 1c). Mixing would be very rapid because of convective transport in this zone, and particle damage can be minimized by keeping the length of the turbulent zone short. Fluids may also be mixed by diffusion.

### EXAMPLE 2

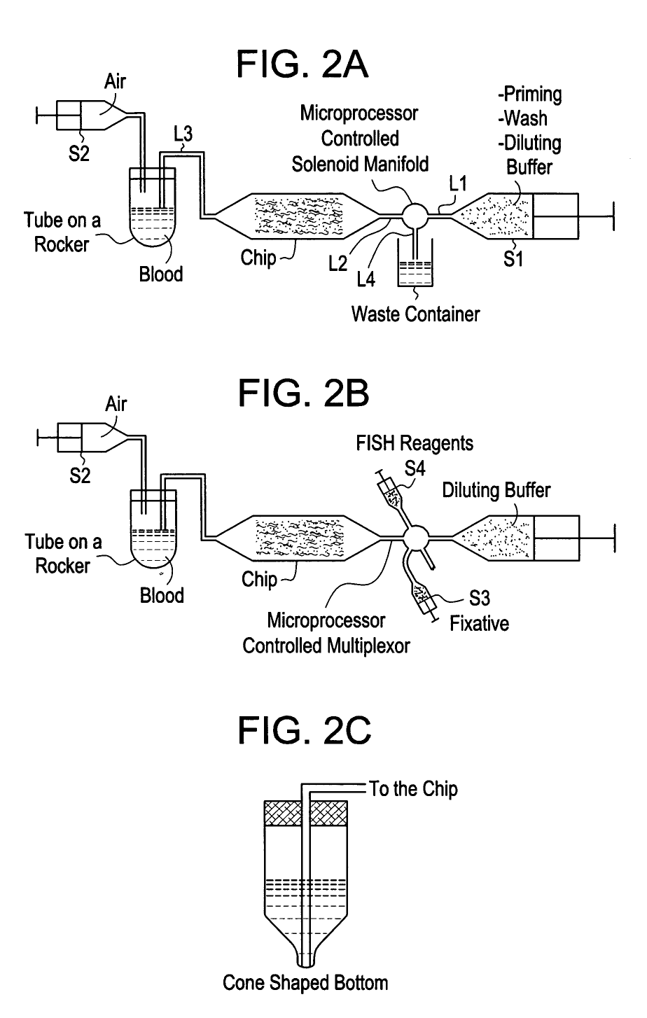

The system is based on the serial fluidic connection of a blood container, an analytical device, and a diluent reservoir. The system makes use of both inlet and outlet connections to the analytical device to enable priming or wetting of the device while diluting the blood sample to any desired volume. FIG. 2a is a schematic representation of the system. The system is operated as follows: a mechanical rocker holds a blood sample in the sample container, diluent from the reservoir is pushed by a positive displacement pump (S1) into the sample container through line L1, a fluidic switch, e.g., a microprocessor controlled solenoid manifold, actuated to block flow to L4, L2, the analytical device, e.g., a microfluidic device, and L3 at a chosen flow rate to enable priming of the device and timely dilution of the blood. The flow rates may range from 0.1-200 ml/hr. Once the blood is diluted to the desired volume, the pumping of S1 is terminated, the diluted blood sample is then pumped by a positive displacement pump (S2) at a desired flow rate through L3, the device, L2, the fluidic switch actuated to block flow to L1, and L4 into a waster container. S2 drives a pressurizing fluid, e.g., air, into the sample container and displaces the blood through L3, the device, and out to waste via L4. A portion of the sample or the entire sample may be passed through the device. At the end of the run, the pumping of S2 is terminated. Further processing may then occur. For example, S1 is reengaged to flush diluent through the device and into the sample container, which now serves as a second waste container. In additional embodiments, additional fluid sources may be coupled to the fluidic switch, as shown in FIG. 2b. In these embodiments, S3 may pump reagents into the analytical device, e.g., to fix and prepare captured blood cells for staining with fluorescent probes, and additional pump S4 may be used to introduce fluorescent probes, e.g., FISH reagents, into the device (FIG. 2b). Additional diluent rinses may also be effected through S1 or additional reservoirs attached to the system. In a preferred embodiment, the sample container has a small diameter cone bottom to contain and submerge the tip of L1 in blood at all times with minimal loss of unprocessed sample (FIG. 2c).

### EXAMPLE 3

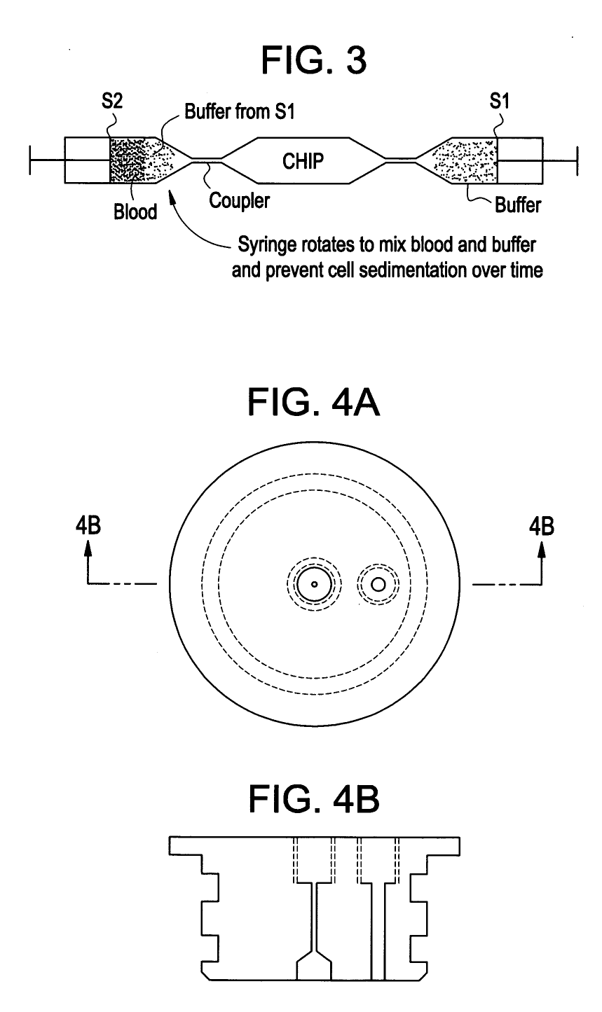

With reference to FIG. 3, another embodiment of the device disposes the blood in a sample container, e.g., a syringe, S2 and the diluent in another container, e.g., a second syringe, S1. S1 is connected to one port of an analytical device, and S2 is connected to another port of the device. Diluent is pumped through the device by displacement, e.g., a combination of push and pull of syringes. The diluent primes the device and dilutes the blood in S2. S2 may be in constant rotation to aid in mixing of the blood and buffer and to prevent cell sedimentation in the container during processing. A coupler may be employed to prevent rotation induced twisting of the fluid line connecting S2 to the device. At least a portion of the diluted blood sample is then passed through the device and into S1.

### EXAMPLE 4

In this embodiment, the system contains two containers in series, a sample container and a diluent reservoir. An amount of blood is pumped by positive displacement from the sample container into the diluent reservoir, both of which are disposed on a mechanical rocker for mixing and sedimentation control. In this embodiment, dilution occurs in a pre-determined volume of buffer in a second tube. A controllable vent may be kept open until the blood sample is displaced into the second tube, after which the vent may be closed to allow subsequent positive displacement pumping to be used to displace the diluted sample from the second tube into an analytical device. A frit or filter on the vent outlet would prevent the discharge of cell-containing aerosols, and any contamination from the outside environment.

### Alternative Embodiments

One skilled may alter the specific components of the systems described in the above-examples to achieve the same purpose. For example, controlling the sedimentation of particles (or otherwise maintaining a homogenous fluid medium), i.e., agitation, may be achieved by any means, including introduction of mechanical or acoustical energy or by circulating the fluid. Examples include a mechanical rocking, magnetic stirring, sonication, or fluid circulating. The frequency and amplitude of sonic waves may be optimized for the particular analytes involved, e.g., living biological cells, to aid in mixing without any deleterious effects on the analytes. For magnetic stirring, a small magnet, preferably poly(tetrafluoroethylene)-coated, could be placed in container requiring mixing, with the container located on a magnetic stir-plate. A relatively low rotational speed such as 1 per second may be employed to avoid damaging the analytes. Furthermore, although separate a input and output are described in the above-examples, a spike containing both or a co-axial input and output may be employed. It is also envisioned that a pressure relief device, e.g., a valve, may be incorporated into any container to be pressurized to avoid hazardous release of analytes, e.g., aerosolized blood, or loss of sample, in the event of a blockage of the tubing or flow passage to the analytical device. Any suitable positive displacement pump may be used to transport fluids. Examples include syringe pumps, positive displacement, such as through introduction of a pressurizing fluid, preferably immiscible in the sample, to a container or through the use of a syringe attached to a syringe pump as a sample container, and regulated pressure sources. One advantage of using a regulated pressure source to drive fluids is that the pressure in the system is limited to the regulated source pressure. Fluids may also be transported via gravity feed, negative displacement (e.g., vacuum), gas pressure, or an immiscible fluid, such as mineral oil. Mixers may also be employed when two fluids are introduced into a transfer line when the Reynolds number is low are when diffusional mixing is insufficient. Such mixers may be employed in the transfer line or at an appropriate point in the analytical device. Such mixers are known in the art. Transfer lines, i.e., fluidic connections, between components of the system may be any material suitable for use with the analytes and fluids employed, e.g., plastics, ceramics, glass, or metals. Connections between components can be made by any suitable, liquid tight connection, as known in the art. In addition, when small sample volumes are employed, connections that have low dead volume are preferable.

Sample Containers

In general, any sample container having at least one fluid port (e.g., an outlet) and being suitable to contain the fluid medium of the sample may be employed in the methods and systems described. Sample containers may also contain more than one port, e.g., for output and to introduce diluent or a pressurizing fluid (such as air, nitrogen, or a fluid immiscible in the sample on the time scale of pumping). A single port may also be used for dual purposes, e.g., input of diluent and output of diluted sample, as described.

In one embodiment, the sample container is closed with a plug as shown in FIG. 4. This plug contains two ports, an outlet in the center of the plug and an inlet spaced apart from the outlet. When the plug is inserted into a sample container, e.g., a 50 mL tube, the tube is inverted, and the sample contacts the plug by gravity. The outlet is connected to a depression on the top of the plug in contact with the sample. When a pressurizing fluid, e.g., air, is introduced into the container through the inlet, the resulting pressure buildup forces sample through the outlet, which may be threaded to fit small compression fittings. Other types of fittings could be used in conjunction with corresponding machined details. The depression isolates a small volume of sample being introduced in the outlet at a given point in time and prevents entrainment of the pressurizing fluid into the sample. The design of the plug also reduces the possibility of pressurizing fluid from being introduced into the outlet during mechanical rocking, while also enabling withdrawal of a greater percentage of the fluid in the vessel. Sealing may be provided by a pair of O-rings, sized in the figure, to fit typical 50 mL conical tubes. Other tube sizes can be accommodated by appropriately sized plugs and O-rings. Alternative sealing arrangements are also possible. For example, the plug may be fabricated from an elastic material and compression fit in the sample container. This plug is advantageous over the use of two needles, one short needle located near the top of a container and one long needle located at the bottom of the container, because of the difficulty of maintaining the long needle on the centerline of the vessel and the limited volume that can be delivered without uncovering the tip of the long needle during mechanical rocking.

Analytical Devices

The methods of the invention may be employed in connection with any analytical device. Examples include affinity columns, particle sorters, e.g., fluorescent activated cell sorters, capillary electrophoresis, microscopes, spectrophotometers, sample storage devices, and sample preparation devices. Microfluidic devices are of particular interest in connection with the systems described herein.

In particular embodiments, the analytical device may be used to isolate various analytes from a mixture, e.g., for collection or further analysis. In one desirable embodiment, rare cells, e.g., fetal red blood cells or cancer cells, are retained in the device, as described in International Application No. PCT/USO3/30965. Analytes retained in the device may, for example, be labeled, e.g., with fluorescent or radioactive probes, subjected to chemical or genetic analysis (such as fluorescent in situ hybridization), or, if biological, cultured.

Analytical devices may or may not include microfluidic channels, i.e., may or may not be microfluidic devices. The dimensions of the channels of the device into which analytes are introduced may depend on the size or type of analytes employed. Preferably, a channel in an analytical device has at least one dimension (e.g., height, width, length, or radius) of no greater than 10, 9.5, 9, 8.5, 8, 7.5, 7, 6.5, 6, 5.5, 5, 4.5, 4, 3.5, 3,2.5, 2, 1.5, or 1 mm. Microfluidic devices employed in the systems and methods described herein preferably have at least one dimension of less than 1, 0.9, 0.8, 0.7, 0.6, 0.5, 0.4, 0.3, 0.2, 0.1, or even 0.05 mm. The dimensions of an analytical device can be determined by one skilled in the art based on the desired application.

Wetting of Devices

In devices that rely on the uniform flow of fluid media, such as buffer-diluted blood, supplied by the dispensing systems described herein, it is preferable to avoid uneven wetting of the analytical device, e.g., in microfluidic channels, that can cause uneven flow because of entrapped gas bubbles in unwet regions. Any wetting method can be employed in combination with an analytical device used in the systems described herein. Methods that address wetting include:

1) Initial flow of buffer containing surfactant: This approach involves using a special buffer tailored to enhance wetting by incorporating a surfactant. This concentration is desirably low enough to avoid damaging the integrity of any analytes.

2) Initial flow of buffer while exposing the device to acoustic vibrations: Acoustic vibration, especially in the ultrasonic regime, can have a beneficial effect in promoting the wetting of surfaces. In this approach, the ultrasonic transducer may be incorporated into the device.

3) Coating portions of the device, e.g., the device lid, with a chemical layer chosen to enhance wetting, e.g., a dried aqueous solution of sugar.

4) Plasma etching of the device: A reactive plasma etch process can reduce the surface tension of aqueous solutions on polymers and other surfaces. For example, improving the wettability of the device lid, e.g., a polymer film, can improve the wettability of the entire device.

5) Assemble the device while submerged under buffer to ensure that the device is substantially wetted and free of gas (e.g., air) bubbles.

Purging the device with carbon dioxide: The purge drives out air, and residual CO₂ is rapidly dissolved into incoming priming buffer because of the high solubility of CO₂ in aqueous solutions. Other gases may be employed in other solvent systems.

### Other Embodiments

All publications, patents, and patent applications mentioned in the above specification are hereby incorporated by reference. Various modifications and variations of the described method and system of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention that are obvious to those skilled in the art are intended to be within the scope of the invention.

Other embodiments are in the claims.

1. A method for delivering analytes to an analytical device, said method comprising the steps of:
(a) providing:
(i) a sample container comprising an outlet and containing a fluid medium comprising said analyte;
(ii) said analytical device; and
(iii) a transfer line fluidically connecting said outlet and said analytical device; and
(b) pumping at least a portion of said fluid medium through said outlet and said transfer line into said analytical device, during which said fluid medium in said sample container is agitated to substantially maintain homogeneity, thereby delivering said analyte to said analytical device.

2. A method for delivering analytes to an analytical device, said method comprising the steps of:
(a) providing:
(i) a sample container comprising an outlet and containing a fluid medium comprising said analytes;
(ii) said analytical device; and
(iii) a transfer line fluidically connecting said outlet and said analytical device, said transfer line comprising a diluent inlet;
(b) pumping at least a portion of said fluid medium through said outlet and into said transfer line, during which said fluid medium in said sample container is agitated to substantially maintain homogeneity;
(c) introducing diluent into said transfer line containing said analytes to produce a diluted sample; and
(d) introducing said diluted sample into said analytical device, thereby delivering said analytes to said analytical device.

3. The method of claim 1, wherein said transfer line further comprises a mixer capable of mixing said fluid medium and said diluent.

4. The method of claim 1, wherein said analytical device comprises a mixer capable of mixing said fluid medium and said diluent.

5. A method for delivering analytes to an analytical device, said method comprising the steps of:
(a) providing
(i) a sample container comprising an outlet and containing a fluid medium comprising said analytes;
(ii) said analytical device;
(iii) a fluidic switch; and
(iv) a diluent reservoir containing diluent;
wherein said outlet is fluidically connected to said analytical device, and said fluidic switch is fluidically connected to said analytical device and said diluent reservoir;
(b) pumping said diluent through said fluidic switch and said analytical device into said sample container to produce a diluted sample, wherein said fluidic switch directs said diluent into said analytical device; and
(c) pumping at least a portion of said diluted sample through said outlet and into said analytical device, during which said diluted sample in said sample container is agitated to substantially maintain homogeneity, thereby delivering said analytes to said analytical device.

6. The method of claim 5, wherein, during step (c), said diluted sample is pumped through said analytical device.

7. The method of claim 5, wherein, during step (c), said fluidic switch prevents said diluted sample from entering said diluent reservoir.

8. A method for delivering analytes to an analytical device, said method comprising the steps of:
(a) providing
(i) a sample container comprising an outlet and containing a fluid medium comprising said analytes;
(ii) said analytical device; and
(iii) a diluent reservoir containing diluent;
wherein said outlet is fluidically connected to said analytical device, and said analytical device is fluidically connected to said diluent reservoir;
(b) pumping diluent from said diluent reservoir through said analytical device and said outlet into said sample container to produce a diluted sample; and
(c) pumping at least a portion of said diluted sample from said sample container through said outlet into said analytical device, during which said diluted sample in said sample container is agitated to substantially maintain homogeneity, thereby delivering said analytes to said analytical device.

9. A method for delivering analytes to an analytical device, said method comprising the steps of:
(a) providing:
(i) a sample container comprising an outlet and containing a fluid medium comprising said analytes;
(ii) a diluent reservoir containing diluent; and (iii) said analytical device,
wherein said outlet is fluidically connected to said diluent reservoir, and said diluent reservoir is fluidically connected to said analytical device;
(b) pumping at least a portion of said fluid medium from said sample container through said outlet into said diluent reservoir to produce a diluted sample, during which said fluid medium in said sample container is agitated to substantially maintain homogeneity; and
(c) pumping at least a portion of said diluted sample from said diluent reservoir into said analytical device, during which said diluted sample in said diluent reservoir is agitated to substantially maintain homogeneity, thereby delivering said analytes to said analytical device.

10. The method of claim 1, wherein said agitating comprises applying mechanical force to said sample container or diluent reservoir.

11. The method of claim 1, wherein said agitating comprises applying acoustical force to said sample container or diluent reservoir.

12. The method of claim 1, wherein said agitating comprises circulating said sample or diluted sample in said sample container or said diluted sample in said diluent reservoir.

13. The method of claim 1, wherein said sample container further comprises an inlet.

14. The method of claim 13, wherein said inlet is not in fluid contact with said fluid medium.

15. The method of claim 13, wherein said inlet and outlet are coaxial.

16. The method of claim 1, wherein said sample container further comprises a pressure release valve.

17. The method of claim 1, wherein said fluid medium comprises a biological fluid.

18. The method of claim 17, wherein said biological fluid comprises blood, lymph, semen, urine, cerebrospinal fluid, saliva, or a cell suspension.

19. The method of claim 1, wherein said pumping of said fluid medium comprises introducing a pressurizing fluid into said sample container, thereby forcing at least a portion of said fluid medium through said outlet.

20. The method of claim 5, wherein said pumping of said diluted sample comprises introducing a pressurizing fluid into said sample container, thereby forcing at least a portion of said diluted sample through said outlet.

21. The method of claim 9, wherein said pumping of said diluted sample comprises introducing a pressurizing fluid into said diluent reservoir, thereby forcing at least a portion of said diluted sample into said analytical device.

22. The method of claim 1, wherein said analytes comprise a particle.

23. The method of claim 22, wherein said particle is a cell.

24. The method of claim 1, wherein, when said analytes are delivered to said analytical device, said analytes are analyzed.

25. The method of claim 24, wherein said analytes are analyzed by contacting said analytes with a labeling moiety.

26. The method of claim 24, wherein said analytes are cells, and said cells are analyzed by in situ hybridization.

27. The method of claim 1, wherein, when said analytes are delivered to said analytical device, a portion of said analytes is selectively retained in said analytical device.

28. The method of claim 27, wherein said analytical device comprises capture moieties capable of selectively binding said portion of said analytes.

29. The method of claim 27, wherein said analytical device comprises a size-based separation medium.

30. The method of claim 1, further comprising, after delivering said analytes to said analytical device, pumping diluent into said analytical device to rinse said analytical device.

31. The method of claim 22, wherein said agitating substantially reduces sedimentation of said particle.

32. A delivery system comprising:
(a) an analytical device;
(b) a transfer line fluidically connected to said analytical device, wherein a sample container is capable of being fluidically connected to said transfer line; and
(c) an agitator capable of substantially maintaining homogeneity in a fluid medium.

33. The delivery system of claim 32, wherein said transfer line comprises a diluent inlet through which diluent can be introduced into said transfer line.

34. The delivery system of claim 32, wherein said transfer line further comprises a mixer capable of mixing diluent and a fluid medium.

35. A delivery system comprising:
(a) an analytical device capable of being fluidically connected to a sample container;
(b) a fluidic switch;
(c) a diluent reservoir; and
(d) an agitator capable of substantially maintaining homogeneity in a fluid medium,
wherein said fluidic switch is fluidically connected to said analytical device and said diluent reservoir, and wherein said fluidic switch is capable of preventing the flow of fluid between said analytical device and said diluent reservoir.

36. A delivery system comprising:
(a) an analytical device capable of being fluidically connected to a sample container;
(b) a diluent reservoir, wherein said analytical device is fluidically connected to said diluent reservoir; and
(c) an agitator capable of substantially maintaining homogeneity in a fluid medium.

37. A delivery system comprising:
(a) a diluent reservoir capable of being fluidically connected to a sample container;
(b) an analytical device fluidically connected to said diluent reservoir; and
(c) an agitator capable of substantially maintaining homogeneity in a fluid medium.

38. A plug for a sample container comprising
(a) a top and a bottom, wherein, when inserted into a sample container, said top is in contact with a sample, and wherein said top further comprises a depression;
(b) a first port traversing said plug from said top to said bottom and in fluidic connection with said depression; and
(c) a second port traversing said plug from said top to said bottom and not in fluidic contact with said depression.

39. The plug of claim 38, wherein said second port is connected to a pressure source.

40. The plug of claim 38, wherein said first port is connected to a transfer line capable of being connected to an analytical device.
